(19) United States
(12) Patent Application Publication
(10) Pub. No.: US 2020/0409940 A1
(43) Pub. Date: Dec. 31, 2020

(54) IMPLEMENTING A BLOCKCHAIN-BASED WORKFLOW

(71) Applicant: Advanced New Technologies Co., Ltd., George Town (KY)

(72) Inventors: Jun Gu, Hangzhou (CN); Shanlu Sun, Hangzhou (CN)

(73) Assignee: Advanced New Technologies Co., Ltd., George Town (KY)

(21) Appl. No.: 16/711,952

(22) Filed: Dec. 12, 2019

Related U.S. Application Data
(63) Continuation of application No. PCT/CN2019/093349, filed on Jun. 27, 2019.

(51) Int. Cl. G06F 16/23; G06F 11/30; G06F 11/34; H04L 9/32

(52) U.S. Cl. CPC G06F 16/2379; G06F 16/2365; H04L 12/46; G06F 11/3495; H04L 9/3242; G06F 11/3006

(57) ABSTRACT

Disclosed herein are methods, systems, and apparatus, including computer programs encoded on computer storage media, for implementing a blockchain-based workflow. One of the methods includes maintaining data identifying one or more states recorded in a blockchain network as triggering states of one or more client service methods to be executed by one or more client devices off the blockchain network participating in a workflow; receiving, from a first client device, a request for executing a transaction on a blockchain network; instructing the blockchain network to execute the transaction; monitoring, by the network server, a state on the blockchain network after execution of the transaction; identifying the state to be a triggering state of a client service method of a second client device participating in the workflow; and sending, to the second client device, a notification that the triggering state is reached.

### CROSS-REFERENCE TO RELATED APPLICATIONS

This application is a continuation of PCT Application No. PCT/CN2019/093349, filed on Jun. 27, 2019, which is hereby incorporated by reference in its entirety.

### TECHNICAL FIELD

This specification relates to implementing a blockchain-based workflow.

### BACKGROUND

Distributed ledger systems (DLSs), which can also be referred to as consensus networks, and/or blockchain networks, enable participating entities to securely and immutably store data. DLSs are commonly referred to as blockchain networks without referencing any particular user case. Examples of types of blockchain networks can include public blockchain networks, private blockchain networks, and consortium blockchain networks. A consortium blockchain network is provided for a select group of entities which control the consensus process and includes an access control layer.

A workflow generally includes a series of activities for completing a task. A workflow can be automated with software tools that apply rules to decide whether one step has been completed successfully and when a next step can begin. In some instances, a workflow system can be designed to compose and execute a series of computational or data manipulation steps. However, complexity of implementing a workflow system can result in low processing efficiency of the workflow system. Therefore, solutions for improving efficiency of workflow systems would be desirable.

### SUMMARY

This specification describes technologies for implementing a blockchain-based workflow. These technologies generally involve implementing a workflow system based on a blockchain network. A workflow can be used in highway construction, airplane manufacturing, ship building, ecommerce, or any other applications. In some embodiments, integrating a workflow with a blockchain network can help simplify implementation of the workflow and improve security and efficiency of the workflow system.

This specification also provides one or more non-transitory computer-readable storage media coupled to one or more processors and having instructions stored thereon which, when executed by the one or more processors, cause the one or more processors to perform operations in accordance with embodiments of the methods provided herein.

This specification further provides a system for implementing the methods provided herein. The system includes one or more processors, and a computer-readable storage medium coupled to the one or more processors having instructions stored thereon which, when executed by the one or more processors, cause the one or more processors to perform operations in accordance with embodiments of the methods provided herein.

It is appreciated that methods in accordance with this specification may include any combination of the aspects and features described herein. That is, methods in accordance with this specification are not limited to the combinations of aspects and features specifically described herein, but also include any combination of the aspects and features provided.

The details of one or more embodiments of this specification are set forth in the accompanying drawings and the description below. Other features and advantages of this specification will be apparent from the description and drawings, and from the claims.

### BRIEF DESCRIPTION OF THE DRAWINGS

FIG. 1 is a diagram illustrating an example of an environment that can be used to execute embodiments of this specification.

FIG. 2 is a diagram illustrating an example of an architecture in accordance with embodiments of this specification.

FIG. 3 is a diagram illustrating an example of a workflow system in accordance with embodiments of this specification.

FIG. 4 is a flowchart illustrating a process that can be executed in accordance with embodiments of this specification.

FIG. 5 is a flowchart illustrating another process that can be executed in accordance with embodiments of this specification.

FIG. 6 depicts examples of modules of an apparatus in accordance with embodiments of this specification.

Like reference numbers and designations in the various drawings indicate like elements.

### DETAILED DESCRIPTION

This specification describes technologies for implementing a blockchain-based workflow. These technologies generally involve implementing a workflow system based on a blockchain network. A workflow can be used in highway construction, airplane manufacturing, ship building, ecommerce, or any other applications. In some embodiments, integrating a workflow with a blockchain network can help simplify implementation of the workflow and improve security and efficiency of the workflow system.

The techniques described in this specification produce several technical effects. In some embodiments, for implementing a blockchain-based workflow, a workflow specification is provided for generating a smart contract executing on a blockchain network and a configurable client service logic for one or more client devices to be executed off the blockchain network. The techniques described herein can integrate the client service logic on the client side with the smart contracts on the blockchain side to implement the workflow. In some embodiments, the smart contract includes one or more state transition methods and the configurable client service logic includes one or more client service methods. A blockchain-based workflow can include the one or more state transition methods in the smart contract and the one or more client service methods in the configurable client service logic.

In some embodiments, the smart contract stores states of the workflow and events indicating change of states into a log file on the blockchain network. By storing the states and events in the log file on the blockchain network, information about the processing status of the workflow (i.e., the states of the workflow) can be more secure and reliable since the log file on the blockchain network is immutable. In some embodiments, a change of the state and event recorded in the blockchain network may automatically trigger one or more client service methods to be executed off the blockchain network. Malicious actors cannot tamper with the information about the states and events of the workflow to compromise the network or to interfere with the normal operations of the workflow. As such, the techniques as described can improve security of the workflow system.

In some embodiments, the workflow can be a joint or collaborative workflow among multiple participants, where each participant can be associated with a client device (e.g., a client device executing the client service logic) or a network node (e.g., a consensus or a non-consensus node that is capable of executing the smart contract) of a blockchain network. In some embodiments, a network node can include a cloud service provider (also referred to as a cloud server) that is communicatively linked with one or more blockchain networks and one or more client devices. The cloud server can serve as a coordinating node of the workflow. The cloud server can be an intermediate node or middleware that provides respective interfaces to one or more blockchain networks and one or more client devices.

In some embodiments, the multi-party blockchain-based workflow can be implemented to facilitate automatic generation of smart contracts (e.g., storing states of the blockchain network, generating state transition methods, and providing role permission control for the state transition methods) according to a workflow specification. In some embodiments, participants of the multi-party collaborative workflow can define a respective portion of the workflow specification, according to individual needs, and execute the client service methods of the client service logic individually. In some embodiments, the multi-party collaborative workflow can provide defined interfaces for each participant of the multi-party collaborative workflow to interact with the blockchain network, relieving the client devices from designing or negotiating compatible interfaces between each other. In some embodiments, client devices of the workflow can focus on the implementation of the client service methods without spending too much effort on details of how the client devices and the smart contract interact with each other.

In some embodiments, the described techniques can help reduce processing and storage requirements on the client devices. In some embodiments, the cloud server can perform heavy-lifting operations and store a large amount of data for the blockchain-based multi-party collaborative workflow including workflow-related states and events. As such, the client devices can be lightweight devices such as user devices or handheld devices that do not need large processing and storage capacities for implementing and participating in blockchain transactions. Also, the client devices can be easily configured, for example, by downloading, synchronizing, compiling, or otherwise receiving the client service logics, as well as any updates or instructions from the cloud server, without the need to develop complicated and compatible client service logics by the client devices. In some embodiments, the multi-party collaborative workflow can have better scalability to accommodate more client devices and are more user friendly to the participants.

In some embodiments, the described techniques can help reduce the storage requirement of the overall workflow system. In some embodiments, the cloud server can serve as a centralized node for coordinating the multi-party collaborative workflow among multiple client devices and multiple blockchain networks. In some embodiments, only one or a few copies of the data for the blockchain-based multi-party collaborative workflow can be stored on the cloud server as opposed to being stored in each of the client devices. The described techniques help simplify implementation of a multi-party collaborative workflow and improve efficiency of workflow systems.

To provide further context for embodiments of this specification, and as introduced above, distributed ledger systems (DLSs), which can also be referred to as consensus networks (e.g., made up of peer-to-peer nodes), and blockchain networks, enable participating entities to securely and immutably conduct transactions, and store data. Although the term blockchain is generally associated with particular networks, and/or use cases, blockchain is used herein to generally refer to a DLS without reference to any particular use case.

A blockchain is a data structure that stores transactions in a way that the transactions are immutable. Thus, transactions recorded on a blockchain are reliable and trustworthy. A blockchain includes one or more blocks. Each block in the chain is linked to a previous block immediately before it in the chain by including a cryptographic hash of the previous block. Each block also includes a timestamp, its own cryptographic hash, and one or more transactions. The transactions, which have already been verified by the nodes of the blockchain network, are hashed and encoded into a Merkle tree. A Merkle tree is a data structure in which data at the leaf nodes of the tree is hashed and all hashes in each branch of the tree are concatenated at the root of the branch. This process continues up the tree to the root of the entire tree, which stores a hash that is representative of all data in the tree. A hash purporting to be of a transaction stored in the tree can be quickly verified by determining whether it is consistent with the structure of the tree.

Whereas a blockchain is a decentralized or at least partially decentralized data structure for storing transactions, a blockchain network is a network of computing nodes that manage, update, and maintain one or more blockchains by broadcasting, verifying, and validating transactions, etc. As introduced above, a blockchain network can be provided as a public blockchain network, a private blockchain network, or a consortium blockchain network. Embodiments of this specification are described in further detail herein with reference to a consortium blockchain network. It is contemplated, however, that embodiments of this specification can be realized in any appropriate type of blockchain network.

In general, a consortium blockchain network is private among the participating entities. In a consortium blockchain network, the consensus process is controlled by an authorized set of nodes, which can be referred to as consensus nodes, one or more consensus nodes being operated by a respective entity (e.g., a financial institution, insurance company). For example, a consortium of ten (10) entities (e.g., financial institutions, insurance companies) can operate a consortium blockchain network, each of which operates at least one node in the consortium blockchain network.

In some examples, within a consortium blockchain network, a global blockchain is provided as a blockchain that is replicated across all nodes. That is, all consensus nodes are in perfect state consensus with respect to the global blockchain. To achieve consensus (e.g., agreement to the addition of a block to a blockchain), a consensus protocol is implemented within the consortium blockchain network. For example, the consortium blockchain network can implement a practical Byzantine fault tolerance (PBFT) consensus, described in further detail below.

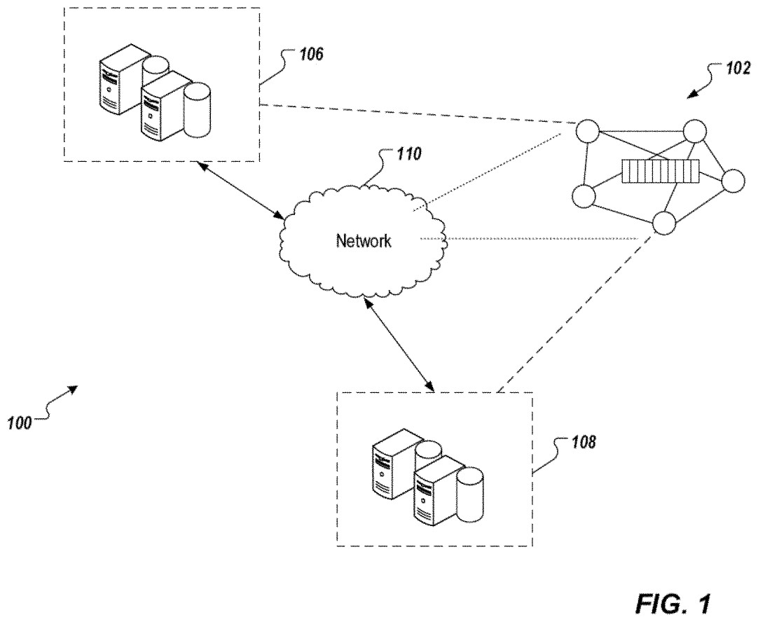

FIG. 1 is a diagram illustrating an example of an environment 100 that can be used to execute embodiments of this specification. In some examples, the environment 100 enables entities to participate in a consortium blockchain network 102. The environment 100 includes computing devices 106, 108, and a network 110. In some examples, the network 110 includes a local area network (LAN), wide area network (WAN), the Internet, or a combination thereof, and connects web sites, user devices (e.g., computing devices), and back-end systems. In some examples, the network 110 can be accessed over a wired and/or a wireless communications link. In some examples, the network 110 enables communication with, and within the consortium blockchain network 102. In general the network 110 represents one or more communication networks. In some cases, the computing devices 106, 108 can be nodes of a cloud computing system (not shown), or each computing device 106, 108 can be a separate cloud computing system including a number of computers interconnected by a network and functioning as a distributed processing system.

In the depicted example, the computing devices 106, 108 can each include any appropriate computing system that enables participation as a node in the consortium blockchain network 102. Examples of computing devices include, without limitation, a server, a desktop computer, a laptop computer, a tablet computing device, and a smartphone. In some examples, the computing devices 106, 108 host one or more computer-implemented services for interacting with the consortium blockchain network 102. For example, the computing device 106 can host computer-implemented services of a first entity (e.g., user A), such as a transaction management system that the first entity uses to manage its transactions with one or more other entities (e.g., other users). The computing device 108 can host computer-implemented services of a second entity (e.g., user B), such as a transaction management system that the second entity uses to manage its transactions with one or more other entities (e.g., other users). In the example of FIG. 1, the consortium blockchain network 102 is represented as a peer-to-peer network of nodes, and the computing devices 106, 108 provide nodes of the first entity, and second entity respectively, which participate in the consortium blockchain network 102.

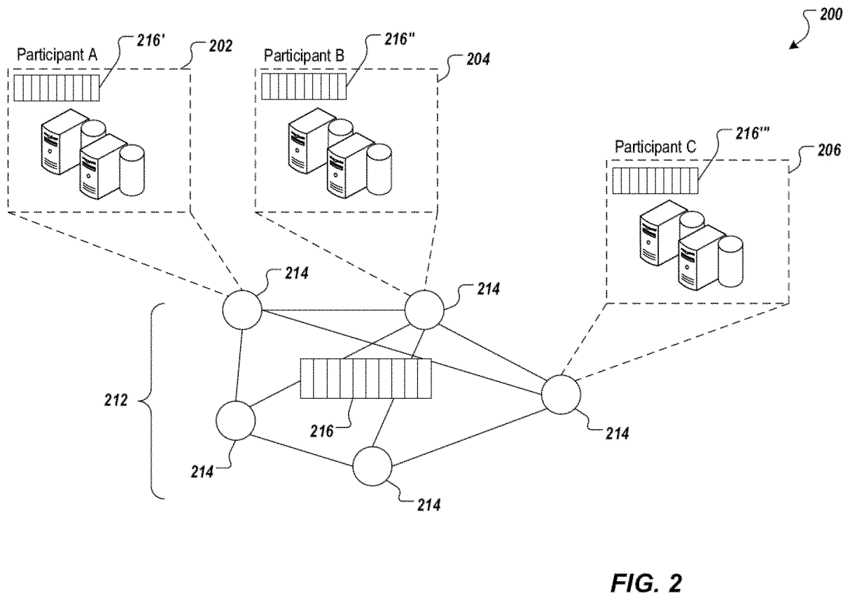

FIG. 2 is a diagram illustrating an example of an architecture 200 in accordance with embodiments of the specification. The example conceptual architecture 200 includes participant systems 202, 204, 206 that correspond to Participant A, Participant B, and Participant C, respectively. Each participant (e.g., user, enterprise) participates in a blockchain network 212 provided as a peer-to-peer network including a plurality of nodes 214, at least some of which immutably record information in a blockchain 216. Although a single blockchain 216 is schematically depicted within the blockchain network 212, multiple copies of the blockchain 216 are provided, and are maintained across the blockchain network 212, as described in further detail herein.

In the depicted example, each participant system 202, 204, 206 is provided by, or on behalf of Participant A, Participant B, and Participant C, respectively, and functions as a respective node 214 within the blockchain network. As used herein, a node generally refers to an individual system (e.g., computer, server) that is connected to the blockchain network 212, and enables a respective participant to participate in the blockchain network. In the example of FIG. 2, a participant corresponds to each node 214. It is contemplated, however, that a participant can operate multiple nodes 214 within the blockchain network 212, and/or multiple participants can share a node 214. In some examples, the participant systems 202, 204, 206 communicate with, or through the blockchain network 212 using a protocol (e.g., hypertext transfer protocol secure (HTTPS)), and/or using remote procedure calls (RPCs).

Nodes 214 can have varying degrees of participation within the blockchain network 212. For example, some nodes 214 can participate in the consensus process (e.g., as miner nodes that add blocks to the blockchain 216), while other nodes 214 do not participate in the consensus process. As another example, some nodes 214 store a complete copy of the blockchain 216, while other nodes 214 only store copies of portions of the blockchain 216. For example, data access privileges can limit the blockchain data that a respective participant stores within its respective system. In the example of FIG. 2, the participant systems 202, 204, and 206 store respective, complete copies 216′, 216″, and 216′″ of the blockchain 216.

A blockchain (e.g., the blockchain 216 of FIG. 2) is made up of a chain of blocks, each block storing data. Examples of data include transaction data representative of a transaction between two or more participants. While transactions are used herein by way of non-limiting example, it is contemplated that any appropriate data can be stored in a blockchain (e.g., documents, images, videos, audio). Examples of a transaction can include, without limitation, exchanges of something of value (e.g., assets, products, services, currency). The transaction data is immutably stored within the blockchain. That is, the transaction data cannot be changed.

Before storing in a block, the transaction data is hashed. Hashing is a process of transforming the transaction data (provided as string data) into a fixed-length hash value (also provided as string data). It is not possible to un-hash the hash value to obtain the transaction data. Hashing ensures that even a slight change in the transaction data results in a completely different hash value. Further, and as noted above, the hash value is of fixed length. That is, no matter the size of the transaction data the length of the hash value is fixed. Hashing includes processing the transaction data through a hash function to generate the hash value. An example of a hash function includes, without limitation, the secure hash algorithm (SHA)-256, which outputs 256-bit hash values.

Transaction data of multiple transactions are hashed and stored in a block. For example, hash values of two transactions are provided, and are themselves hashed to provide another hash. This process is repeated until, for all transactions to be stored in a block, a single hash value is provided. This hash value is referred to as a Merkle root hash, and is stored in a header of the block. A change in any of the transactions will result in change in its hash value, and ultimately, a change in the Merkle root hash.

Blocks are added to the blockchain through a consensus protocol. Multiple nodes within the blockchain network participate in the consensus protocol, and perform work to have a block added to the blockchain. Such nodes are referred to as consensus nodes. PBFT, introduced above, is used as a non-limiting example of a consensus protocol. The consensus nodes execute the consensus protocol to add transactions to the blockchain, and update the overall state of the blockchain network.

In further detail, the consensus node generates a block header, hashes all of the transactions in the block, and combines the hash value in pairs to generate further hash values until a single hash value is provided for all transactions in the block (the Merkle root hash). This hash is added to the block header. The consensus node also determines the hash value of the most recent block in the blockchain (i.e., the last block added to the blockchain). The consensus node also adds a nonce value, and a timestamp to the block header.

In general, PBFT provides a practical Byzantine state machine replication that tolerates Byzantine faults (e.g., malfunctioning nodes, malicious nodes). This is achieved in PBFT by assuming that faults will occur (e.g., assuming the existence of independent node failures, and/or manipulated messages sent by consensus nodes). In PBFT, the consensus nodes are provided in a sequence that includes a primary consensus node, and backup consensus nodes. The primary consensus node is periodically changed, Transactions are added to the blockchain by all consensus nodes within the blockchain network reaching an agreement as to the world state of the blockchain network. In this process, messages are transmitted between consensus nodes, and each consensus node proves that a message is received from a specified peer node, and verifies that the message was not modified during transmission.

In PBFT, the consensus protocol is provided in multiple phases with all consensus nodes beginning in the same state. To begin, a client sends a request to the primary consensus node to invoke a service operation (e.g., execute a transaction within the blockchain network). In response to receiving the request, the primary consensus node multicasts the request to the backup consensus nodes. The backup consensus nodes execute the request, and each sends a reply to the client. The client waits until a threshold number of replies are received. In some examples, the client waits for f+1 replies to be received, where f is the maximum number of faulty consensus nodes that can be tolerated within the blockchain network. The final result is that a sufficient number of consensus nodes come to an agreement on the order of the record that is to be added to the blockchain, and the record is either accepted, or rejected.

In some blockchain networks, cryptography is implemented to maintain privacy of transactions. For example, if two nodes want to keep a transaction private, such that other nodes in the blockchain network cannot discern details of the transaction, the nodes can encrypt the transaction data. An example of cryptography includes, without limitation, symmetric encryption, and asymmetric encryption. Symmetric encryption refers to an encryption process that uses a single key for both encryption (generating ciphertext from plaintext), and decryption (generating plaintext from ciphertext). In symmetric encryption, the same key is available to multiple nodes, so each node can en-/de-crypt transaction data.

Asymmetric encryption uses keys pairs that each include a private key, and a public key, the private key being known only to a respective node, and the public key being known to any or all other nodes in the blockchain network. A node can use the public key of another node to encrypt data, and the encrypted data can be decrypted using other node's private key. For example, and referring again to FIG. 2, Participant A can use Participant B's public key to encrypt data, and send the encrypted data to Participant B. Participant B can use its private key to decrypt the encrypted data (ciphertext) and extract the original data (plaintext). Messages encrypted with a node's public key can only be decrypted using the node's private key.

Asymmetric encryption is used to provide digital signatures, which enables participants in a transaction to confirm other participants in the transaction, as well as the validity of the transaction. For example, a node can digitally sign a message, and another node can confirm that the message was sent by the node based on the digital signature of Participant A. Digital signatures can also be used to ensure that messages are not tampered with in transit. For example, and again referencing FIG. 2, Participant A is to send a message to Participant B. Participant A generates a hash of the message, and then, using its private key, encrypts the hash to provide a digital signature as the encrypted hash. Participant A appends the digital signature to the message, and sends the message with digital signature to Participant B. Participant B decrypts the digital signature using the public key of Participant A, and extracts the hash. Participant B hashes the message and compares the hashes. If the hashes are same, Participant B can confirm that the message was indeed from Participant A, and was not tampered with.

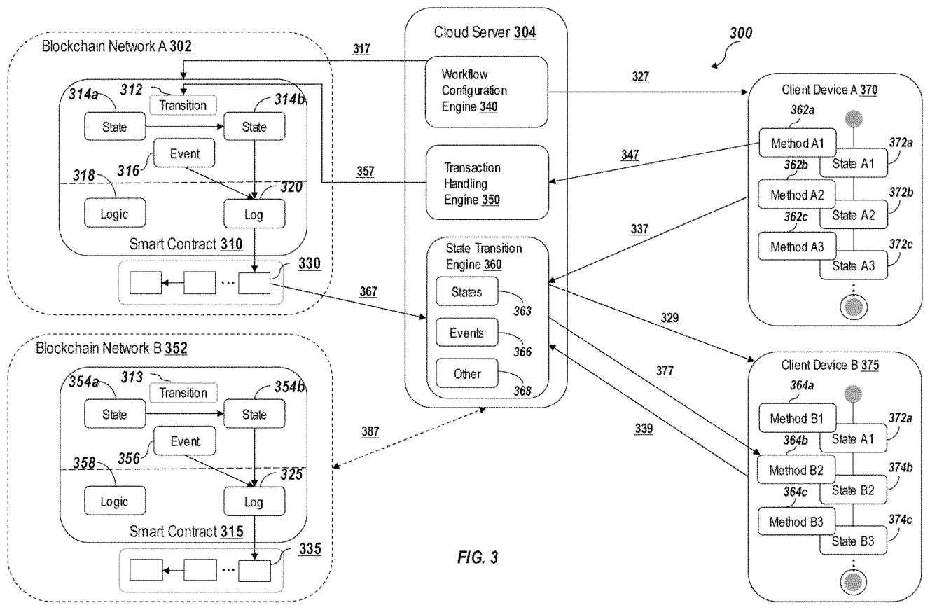

FIG. 3 is a diagram illustrating an example of a system 300 in accordance with embodiments of this specification. The example system 300 implements a workflow based on a blockchain network. In some embodiments, the workflow can be a joint or a multi-party workflow among multiple participants and each participant can be associated with a client device or network node of a blockchain network (e.g., client devices executing the client service logic and blockchain network nodes executing the smart contract). As an example, the system 300 includes one or more blockchain networks (e.g., a blockchain network A 302 and blockchain network B 352), a cloud server (or cloud service provider) 304, and one or more client devices (e.g., a client device A 370 and a client device B 375). In some embodiments, the blockchain network 302 or 352 can be a consortium blockchain network. The cloud server 304 and the client device 370 or 375 can include, for example, any suitable computer, module, server, or computing element programmed to perform methods described herein. In some embodiments, the client device can include a user device, such as, a personal computer, a smartphone, a tablet, or other handheld device.

In some embodiments, the system 300 implements a joint workflow based on blockchain network such that each of the participants (e.g., the client devices 370 or 375) involved in the workflow can process at least a part of the workflow and interact with other participants via the blockchain network A 302 (e.g., using a smart contract (e.g., smart contract 310) executing on the blockchain network 302), the blockchain B 352 (e.g., using a smart contract (e.g., smart contract 315) executing on the blockchain network 352), or both. In some embodiments, the cloud server 304, the client device 370 or 375, or both can include a data store (e.g., a database) for storing states, events, and other data for implementing the workflow logic. In some embodiments, the cloud server 304 stores the states 314, events 316, and other data 342 for implementing the workflow logic and provides these data to the client device 370 or 375, whereas the client device 370 or 375 can be lightweight devices and do not need to have large processing and storage capabilities.

In some embodiments, a workflow can include a series of activities for completing a task. In some embodiments, each activity or step in a workflow may have a specific step before it and a specific step after it, with the exception of the first step and the last step. A workflow can be a linear workflow where the first step is usually initiated by an outside event, or a loop structure where the first step is initiated by the completion of the last step. A workflow can be automated with software tools that apply predetermined rules to decide when one step has been completed successfully and when the next step can begin. For example, a workflow system can be designed specifically to compose and execute a series of computational or data manipulation steps based on a blockchain network (e.g., the blockchain network 302 or 352). Examples of computerized workflows include computer scripts that call in data, programs, and other inputs and produce outputs that can include visualizations and analytical results. These workflows may be implemented in programs using any suitable programming language such as C/C++, JAVA, R, or MATLAB, or using a scripting language such as PYTHON or PERL with a command-line interface. A workflow system can be developed based on visual flowcharting, logic diagramming, or program coding to describe a workflow logic or engine that is executed by the workflow participants.

In some embodiments, the cloud server 304 can serve as an intermediate node or coordinating node among the participants of the multi-party workflow. For example, the cloud server 304 can identify or allocate tasks (e.g., client service methods 362a-c and 364a-c) to different workflow participants (e.g., client devices 370 and 375), and communicate with each of the participants as well as the blockchain networks (e.g., a blockchain network A 302 and blockchain network B 352). In some embodiments, the cloud server 304 can include a workflow configuration engine 340 (e.g., for generating client service logics and/or smart contract logics), a transaction handling engine 350 (e.g., for handling transaction requests from the client devices and responses from the blockchain networks), and a state transition engine 360 (e.g., for monitoring and maintaining state transitions and interacting with the client devices and the blockchain networks). In some embodiments, the cloud server 304 can include additional or different components for implementing the multi-party workflow.

In some embodiments, the workflow configuration engine 340 can generate one or more workflow logic executable by one or more computers. A workflow logic can include defined operations in one or more processes, manage and monitor the state of activities or methods 362a-c in a workflow, and determine which new activity to transition to according to the defined operations, thereby facilitating the flow of information, tasks, and events. In some embodiments, a workflow logic can include functions such as (1) verifying a current process status (e.g., checking whether it is valid to execute a task given a current state or status), (2) determining the authority of an executing participant (e.g., checking if the participant requesting to execute the task is permitted or authorized to execute the task) and (3) executing the task (e.g., by executing a condition script after passing the previous verification, the workflow logic proceeds to execution of the task, and if the execution successfully completes, it returns a result; if not, it reports an error to a trigger or requestor of the task).

In some embodiments, one or more of a state, event, role, transition method, client service method, and context can be defined for implementing the workflow.

In some embodiments, a state of a workflow can indicate a processing status of the workflow. In some embodiments, a state can be configured to record one or more computer system events and/or user interactions. In some embodiments, a state is represented by one or more values of one or more parameters or variables defined in the workflow (e.g., as a string, one or more digits, etc.) stored in the blockchain system or network. Examples of states in an ecommerce workflow includes “Start,” “Item Available,” “Offer Placed,” or “Accepted.” Different states can be defined in other workflows such as in highway construction, airplane manufacturing, ship building, or any other applications.

In some embodiments, an event can include an indication of a transition of states of the workflow. For example, an event can indicate that a state of the workflow has changed to a target state. In some embodiments, an event is represented by one or more values of one or more parameters or variables defined in the workflow (e.g., as a string, one or more digits, etc.) stored in the blockchain system or network. Examples of events include “is Start Now,” “is Item Available Now,” “is Offer Placed Now,” “is Accepted Now,” and “is Rejected Now,” etc. In these examples, the event “is Start Now” can indicate that the workflow has changed to the state “Start”, and the event “is Item Available Now” can indicate that the workflow has changed to the state “Item Available.”

In some embodiments, the states and events are common variables used between the smart contract deployed in the blockchain network and the workflow logic of a client device. The states and events can be commonly defined and used between the smart contract and the workflow logic facilitates integration of the workflow logic of the client device with the blockchain network and the communication of states and events of the workflow among the participants of the workflow.

In some embodiments, the transition of states in the workflow can be recorded in the blockchain, for example, by calling state transition methods. In some embodiments, a state transition method includes a computer program or procedure that can be executed, for example, by a blockchain node executing the smart contract, to change a state of the workflow to a target state. In some embodiments, the state transition methods can log the current state, event, and other data in the smart contract. In some embodiments, a state transition method can specify at least one of the following: a name of state transition method, one or more roles that are allowed to access the state transition method, a state list including states that can be changed to another state, one or more target states, one or more events, or some optional parameters. Examples of state transition methods include “init Item,” “make Offer,” “accept Offer,” and “reject,” etc. In these examples, the state transition method “make Offer” can specify a name as “offer Price,” a type as “unit 32”, a role as “buyer,” a state as “Item Available,” a target state as “Offer Placed,” and an event as “is Offer Placed Now.”

In some embodiments, a client service method can be a computer program or procedure configured to detect a current state of the workflow by retrieving a blockchain block from the blockchain network. In some embodiments, if the detected state matches a predefined state, the client service method can be executed to provide a certain service to clients and generate a target state. In some embodiments, a client service method specifies a triggering state, a triggering event, and a target state. In some embodiments, the target state can be optionally defined in the client service methods. In some embodiments, a client service method can generate the target state in response to determining a current state of the workflow being the triggering state and detecting the triggering event that causes a change from the triggering state to the target state. Examples of client service methods include “Init Item Fun,” “Make Offer Fun,” “Accept Fun,” etc. In these examples, the client service method “Make Offer Fun” can specify a triggering state “Item Available,” a triggering event “is Item Available Now,” a target state “offer Placed,” and a function “Make Offer Fun.” If it is determined that a detected state and event match the triggering state “Item Available” and triggering event “is Item Available Now” respectively, the function “Make Offer Fun” can be executed to make an offer to an item and the target state “offer Placed” is generated accordingly.

In some embodiments, the use of a smart contract can provide better access control of the state transition methods. For example, a role can be defined to provide access control to the state transition methods. In some embodiments, each participant of the workflow is associated with a role. In the workflow with multiple participants, a state transition method may specify certain roles that have authority to execute the state transition method. Examples of the roles in an ecommerce system include “Buyer,” “Seller,” and “Shipper.” In some embodiments, a role is represented by one or more values of one or more parameters or variables defined in the workflow (e.g., as a string, one or more digits, etc.) stored in the blockchain system or network. For example, a role can include an account identity (e.g., a hash value of an account name) of a blockchain account.

In some embodiments, a context can include input data for the client service methods. In some embodiments, the context can be stored in a local data base at a client device. In some embodiments, the context can be a result returned by a remote procedure call (RPC). In some embodiments, a client device can parse the log data of the smart contract from the blockchain block and initialize the context input so that the client service methods can get the data returned by the smart contract. In some embodiments, the context includes a client name, an account name, a smart contract name, and supplemental data. Examples of supplemental data include price and quality of an item and data types (e.g., integer, etc.) of the price and quality.

In some embodiments, a workflow specification can be used to design a blockchain-based workflow system and generate a workflow logic. In some embodiments, the workflow specification can define one or more of a state, event, role, transition method, client service method, and context. In some embodiments, the workflow specification indicates one or more state transition methods to be performed by a smart contract on a blockchain network, and one or more client service methods to be executed by one or more client devices off the blockchain network participating in a workflow. In some embodiments, the workflow specification can be obtained, for example, by the coordinator of a blockchain-based workflow system (e.g., an owner or operator of the blockchain network or a third-party service provider for providing the blockchain-based workflow system). In some embodiments, the workflow specification can be negotiated and predetermined by the participants of the workflow. For example, the participants of the workflow can provide their respective client service methods (e.g., by filling a specification form or sheet), data exchanges or interactions among participants, and determine overall workflow among the participants.

In some embodiments, based on the workflow specification, one or more client service logics to be executed off the blockchain network by the one or more client devices corresponding to the participants of the workflow can be generated and provided to the respective client devices corresponding to the participants of the workflow, for example, by the coordinator of the blockchain-based workflow system.

In some embodiments, the one or more client service logics can be configurable by the respective client devices. For example, the one or more client service logics can be in the form of a SDK such that the one or more client devices can fill in or modify their respective methods as a part of the overall workflow. In some embodiments, the one or more client service logics can include defined application interfaces between or among the client service logics, or between the client service logics and the blockchain network (e.g., via the smart contract), which can provide a uniform and consistent framework to facilitate interactions among all the participants of the workflow and the blockchain network as well as improving the compatibility, scalability, flexibility, and efficiency of the workflow system.

In some embodiments, based on the workflow specification, one or more smart contracts to be executed on the blockchain network can be generated, for example, by the coordinator of the blockchain-based workflow system. The one or more smart contracts can include the one or more state transition methods. In some embodiments, the one or more smart contracts can be generated based on one or more smart contract templates with functions related to the client service methods filled in based on the workflow specification. Alternatively or additionally, the functions related to the client service methods can be filled in by one or more participants of the workflow. The one or more smart contracts can be deployed on the blockchain network and be invoked by a network node or a client device of the blockchain network. The one or more smart contracts can include defined interfaces to the coordinator of the blockchain-based workflow system and/or one or more client service logics to be executed off the blockchain network.

As an example shown in FIG. 3, the workflow configuration engine 340 can generate one or more workflow logics to be deployed and executed by one or more of the client device 370 or 375, for example, based on a workflow specification. In some embodiments, the workflow configuration engine 340 can send respective workflow logics to the client devices 370 and 375, as indicated by 327 and 329, respectively. As illustrated, the workflow logic of the client device 370 includes client service methods 362a-c; and the workflow logic of the client device 375 includes client service methods 364a-c. Note that the workflow logics are shown to include three client service methods for illustrative purposes only. The workflow logic of the client device 370 or 375 can have any suitable number of client service methods.

In some embodiments, the workflow logic of the client device 370 or 375 can be a configurable client service logic and the client service methods 362a-c or 364a-c can include computing procedures executed by a computing element. For example, the workflow logics of the client device 370 can be a programming logic that is stored on client device 370 and can include the client service methods 362a-c to be executed by the client device 370 to perform certain computational operations and achieve a certain function (e.g., generate a certain output). In some embodiments, the workflow logic can include a software development kit (SDK) configurable by the client device 370 or 375 off the blockchain network 302 or 352. In some embodiments, each of the client device 370 and 375 can be configured to execute the workflow logics. In some embodiments, each of the client devices 370 and 375 can be configured to execute a portion of the workflow logic. For example, each of the client devices 370 and 375 can be configured to execute a subset of the methods 362a-c.

In some embodiments, the client service methods 362a-c and 364a-c can be configured to change states of the workflow. In some embodiments, a triggering state, a triggering event, a target state, or a combination of them can be defined in each of the client service methods 362a-c and 364a-c. In some embodiments, the target state can be optionally defined in the client service methods. In some embodiments, a client service method can generate the target state in response to determining a current state of the workflow being the triggering state and detecting the triggering event that causes a change from the triggering state to the target state.

In some embodiments, the workflow logics of the client devices 370 and 375 includes one or more application interfaces with the cloud server 304, for example, for requesting transactions to be executed on the blockchain network 302 or 352. For example, the workflow logics of the client devices 370 and 375 can include defined interfaces for calling one or more state transition methods 312 defined in a smart contract 310, and/or one or more state transition methods 313 defined in a smart contract 315, to change and record the states of the workflows of the client devices 370 and 375.

As an example shown in FIG. 3, the workflow configuration engine 340 can generate one or more smart contracts (e.g., smart contracts 310 and 315) to be executed by the blockchain networks 302 and 352. In some embodiments, the workflow configuration engine 340 can send respective smart contracts 310 and 315 to the blockchain networks 302 and 352, as indicated by 317 and 387 respectively. The smart contracts 310 and 315 can be saved as smart contract logics 318 and 358 the network nodes of the blockchain networks 302 and 352, respectively. The smart contracts 310 and 315 can be deployed and executed by the network nodes of the blockchain networks 302 and 352, respectively.

In some embodiments, the smart contracts 310 and 315 can include one or more state transition methods 312 and 362, respectively. In some embodiments, the smart contracts 310 and 315 can be called to execute one of the state transition methods 312 and 313 to change a current state stored in the blockchain network 302 and 352 (e.g., in log files 320 and 325, and/or blockchains 330 and 335) to another state, respectively. In some embodiments, the smart contract 310 or 315 can be executed to store a number of states (e.g., states 314a-b, states 354a-b, etc.) and events (e.g., event 316, event 356, etc.) in the log file or data (e.g., log files 320 and 325) of network nodes of the blockchain network 302 and 352. The log files 320 and 325 can be further recorded in blockchains 330 and 335 on the blockchain networks 302 and 352, respectively.

In some embodiments, the smart contract 310 or 315 can include defined interfaces between one or more parties or participants of the workflow system and the blockchain network (e.g., the cloud server 304). In some embodiments, the smart contract 310 or 315 can include functions or operations that can be performed by one or more of the parties or participants of the workflow system. For example, the functions or operations can include a function for the client device 370 or 375 to call the smart contract 310 or 315 to execute one of the state transition methods 312 or 313. In some embodiments, the smart contract 310 or 315 can define authorized entities for performing certain functions. The smart contract can facilitate enforcing trackable and credible interactions between participating entities and blockchain networks.

In some embodiments, the smart contracts 310 and 315 can specify one or more roles that are configured to provide access control to the state transition methods 312 and 313, respectively. Examples of the roles in an ecommerce system include “Buyer” and “Seller,” etc. In some embodiments, each of the roles includes an account identity (e.g., a hash value of an account name) of a blockchain account. In some embodiments, the roles are configured to provide access control to the state transition methods 312 and 313 such that a blockchain account associated with one of the roles can be allowed to access one or more of the state transition methods 312 and 313.

In some embodiments, the cloud server 304 can handle workflow related transactions, for example, by the transaction handling engine 350. For example, the transaction handling engine 350 can receive transaction requests from the client device 370 or 375, analyze the transaction requests, and send the transaction requests to the blockchain networks 302 or 352. In some embodiments, the transaction handling engine 350 can receive transaction responses from the blockchain networks 302 or 352, analyze the transaction responses, and send the transaction responses to the client devices 370 or 375.

As an example, the client device 370 executes a first client service method (e.g., “Method A1”) 362a in the workflow logic. In some embodiments, the first client service method 362a has a triggering state, a triggering event, and a target state. In some embodiments, the client device 370 detects the triggering state, for example, by retrieving a state from a most recent blockchain block 330 of the blockchain network 302, and executes the first client service method 362a, resulting in the target state (e.g., “State A1”) 372a. In some embodiments, the client device 370 can send a transaction request to record the target state 372a on the blockchain network 302.

In some embodiments, at 347, the client device 370 sends a transaction request to the transaction handling engine 350 requesting to record the target state 372a on the blockchain network 302. Upon reception of the transaction request from the client device 370, at 357, the transaction handling engine 350 can make a contract call to the smart contract 310 deployed on the blockchain network 302, for example, to execute the state transition method 312 to update the state 314b to be the target state (e.g., “State A1”) 372a.

In some embodiments, the blockchain network 302 (e.g., a consensus node of the blockchain network 302) receives the contract call to the smart contract 310 to execute the state transition method 312. The blockchain network 302 can perform a consensus process of the contract call, and then execute the state transition method 312 to update the state 314b to be the target state (e.g., “State A1”) 372a of the first client service method 362a. In some embodiments, in executing the smart contract, the blockchain network 302 determines whether a blockchain account associated with the client device 370 is authorized to make such a contract call to execute the state transition method 312. For example, a state transition method in the smart contract can be defined such that one or more roles are authorized to access the state transition method, while the other roles are not allowed to access the state transition method.

In some embodiments, the state transition method 312 can generate an event 316 indicating a change of the current state of the smart contract 310 to the target state (e.g., “State A1”) 372a. After the state transition method 312 is executed, the target state becomes a new current state. In some embodiments, the new current state and the event are stored to the blockchain network 302. In some embodiments, the state and the event are stored to a log file 320 in the smart contract 310. In some embodiments, the log file 320 is further recorded in a blockchain 330 that is stored on the blockchain network 302.

In some embodiments, the client device 370 may request to record the state transition on additional or different blockchain networks. For example, the client device 370 can send a transaction request to the transaction handling engine 350 requesting to record the target state 372a on the blockchain network 352. In some embodiments, the transaction handling engine 350 can analyze the transaction request, determine where to send the transaction request to, and make a contract call to a smart contract deployed on the corresponding blockchain network accordingly.

In some embodiments, the transaction handling engine 350 can determine whether a blockchain account associated with the client device 370 is authorized to make such a contract call to methods defined in smart contracts of the requested blockchain network. If not, the transaction handling engine 350 can reject the client device 370's transaction request.

In some embodiments, the cloud server 304 can monitor a current state and/or event of the workflow from the blockchain networks 302 and 352. For example, the cloud server 304 (e.g., via the state transition engine 360) can constantly or regularly detect, retrieve, pull, or otherwise determine a current state and event of the workflow from the blockchain 330 or 335 of the blockchain network 302 or 352, respectively, for example, as indicated by 367 and 387. In some embodiments, the cloud server 304 can subscribe to information (e.g., states and/or events related to the joint workflow) stored in the blockchain. In some embodiments, the blockchain network 302 and/or 352 can push or otherwise send to the cloud server 304 constantly or regularly (e.g., periodically) information stored in the blockchain. As such, the cloud server 304 can obtain latest information of the blockchain.

In some embodiments, the cloud server 304 can maintain a local copy of states 363, events 366, and other data 368 related to the joint workflow. For example, the cloud server 304 can constantly or regularly pull and synchronize with the blockchains 330 and 335 of the blockchain network 302 or 352. In some embodiments, the state transition engine 360 can access the states 363, events 366, and other data 368 stored on the cloud server 304, for example, to determine if one or more triggering states and/or events of a client device method are detected.

In some embodiments, the cloud server 304 can receive subscription or registration of one or more triggering states and/or events of client device methods of the client devices 370 and 375. For example, as indicated by 337 and 339, the client devices 370 and 375 can send subscription or registration requests of the one or more triggering states and/or events of client device methods of the client devices 370 and 375 to the state transition engine 360 such that upon an occurrence of a triggering state and/or event on the blockchain network, the state transition engine 360 notify or alert the triggering state and/or event to the client devices 370 and 375, respectively.

In some embodiments, the state transition engine 360 can determine a current state and/or event recorded in the blockchain networks 302 and 352, compare it with the triggering states and/or triggering events subscribed to or registered on the cloud server 304, respectively. Upon determining that there is a match for the triggering state and/or event, the state transition engine 360 can send a notification to a corresponding client device 370 or 375.

For example, as shown in FIG. 3, the client service method, “Method B2” 364b, in the workflow logic of the client device 375 has a triggering state, “State A1” 372a, and a target state, “State B2” 374b. The cloud server 304 determines that a current state recorded in the blockchain network 302, is the “State A1” 372a, matches the triggering state of the client service method, “Method B2” 364b, of the client device 375. In response, the cloud server 304 sends a notification to the client device 375 to alert the occurrence of the triggering state “State A1” 372a at 377. Upon reception of the notification of the triggering state “State A1” 372a from the cloud server 304, the client device 375 can proceed to execute the next client method, “Method B3” 364c, in the workflow logic of the client device 375.

In some embodiments, the client device 375 executes the client service method, “Method B3” 364c, and generates an output indicating a target state, “State B3” 374c. The client device 375 can send a transaction request to the cloud server 304 (e.g., the transaction handling engine 350) requesting to record the target state, “State B3” 374c, on the blockchain network 302.

Upon reception of the transaction request from the client device 370, the transaction handling engine 350 can make a contract call to the smart contract 310 deployed on the blockchain network 320, for example, to execute the state transition method 312 to update the state 314b to be the target state, “State B3” 374c. In some embodiments, before making the contract call to the smart contract 310, the cloud server 304 determines whether a blockchain account associated with the client device 375 is authorized to make such a contract call to execute the state transition method 312. If the cloud server 304 determines that the blockchain account associated with the client device 375 is not authorized to make such a contract call to execute the state transition method 312, the cloud server 304 may discard the transaction request from the client device 375 or may send a notification to the client device 375.

In some embodiments, the blockchain network 302 (e.g., a consensus node of the blockchain network 302) receives the contract call to the smart contract 310 to execute the state transition method 312. The blockchain network 302 can perform a consensus process of the contract call, and then execute the state transition method 312 to update the state 314b to be the target state “State B3” 374c of the client service method 364c. In some embodiments, in executing the smart contract, the blockchain network 302 determines whether a blockchain account associated with the client device 375 is authorized to make such a contract call to execute the state transition method 312. In some embodiments, the state transition method 312 can also generate an event 316 indicating changing the state 314a (e.g., state “State A1” 372a) to state 314b (e.g., state “State B3” 374c in this example). The state 314b can be stored to the log file 320 along with the event 316. The log file 320 can be further recorded in a blockchain 330 in the blockchain network 302.

In some embodiments, the state “State B3” 374c may be a triggering state of another client service method of the client device 370 or 375 (e.g., the client service method “Method B2” 364c of the client device 375). The cloud server 304 can monitor and maintain the state on the blockchain network 302 and alert the corresponding client device once a triggering state of the client device occurs and is recorded on the blockchain network.

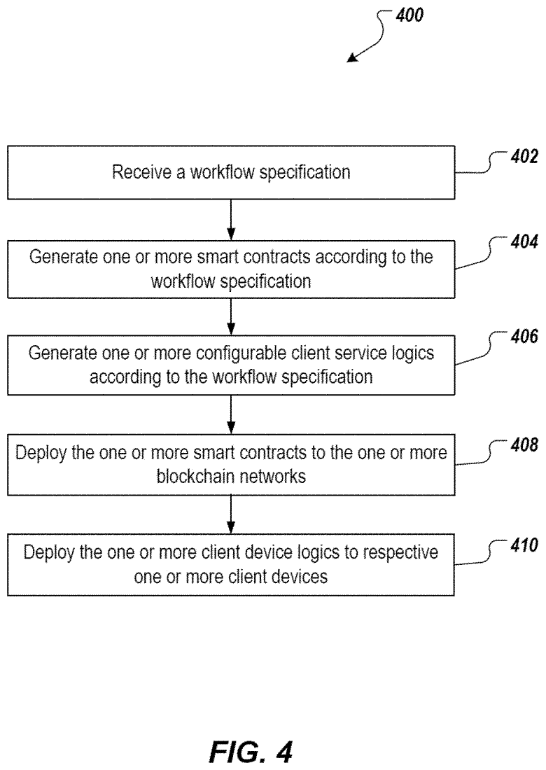

FIG. 4 is a signal flow illustrating an example of a process 400 that can be executed in accordance with embodiments of this specification. The signal flow represents a process 400 for generating workflow logics for implementing a blockchain-based workflow. For convenience, the process will be described as being performed by a system of one or more computers, located in one or more locations, and programmed appropriately in accordance with this specification. For example, the system 300 of FIG. 3, appropriately programmed, can perform the process.

At the outset, a smart contract can be generated according to a workflow specification and deployed on a blockchain network (e.g., the blockchain network 302 or 352).

At 402, a workflow specification is received. In some embodiments, the workflow is received by an intermediate node or coordinating node of the workflow (e.g., the cloud server 304), a blockchain network (e.g., a consensus node or a non-consensus node of the blockchain network), and/or client devices off the blockchain network. In some embodiments, the workflow specification can be the workflow specification described with respect to FIG. 3. For example, the workflow specification indicates one or more state transition methods to be performed by a smart contract on the blockchain network, and one or more client service methods to be performed by one or more client devices off the blockchain network participating in a workflow.

The workflow specification can specify a number of state transition methods and can be used to generate the smart contract such that the smart contract includes the number of state transition methods. The workflow specification can also specify a series of client service methods (e.g., client service methods 362a-c and 364a-c) to be performed by the client devices (e.g., the client device 370 or 375) participating the workflow. A workflow logic can be generated according to the workflow specification such that the workflow logic includes one or more client service methods. Each of the client devices can be configured to execute the workflow logic or a portion of the workflow logic (e.g., a subset of the client service methods of the workflow logic).

At 404, one or more smart contracts are generated according to the workflow specification. In some embodiments, one or more smart contracts are generated by the coordinating node of the workflow (e.g., the workflow configuration engine 340 of the cloud server 304). In some embodiments, the one or more smart contracts are to be executed on the one or more blockchain networks. In some embodiments, a smart contract can include one or more state transition methods and one or more states. In some embodiments, at least one state of the one or more states automatically triggers one or more client service methods to be executed by a client device off the blockchain network. For example, the smart contract can define a state as a triggering state and an event as a triggering event for a specified client service method executable by a specified client device. In some embodiments, as described with respect to FIG. 3, if execution of the smart contract leads to the triggering state and the triggering event, the coordinating node of the workflow can automatically send a signaling or instruction to the specified client device to invoke execution of the specified client service method by the specified client device off the blockchain. In some embodiments, the smart contract and the specified client service method include respective interfaces and logics that identify the triggering state and the triggering event for the execution of the specified client service method.

At 406, one or more configurable client service logics are generated according to the workflow specification for one or more client devices. In some embodiments, the one or more configurable client service logics are generated by the coordinating node of the workflow (e.g., the workflow configuration engine 340 of the cloud server 304). In some embodiments, the one or more configurable client service logics are to be executed by the one or more client devices off the blockchain network.

In some embodiments, the client service logic includes one or more client service methods. In some embodiments, the workflow specification specifies one or more states and events (e.g., a triggering state and a triggering event for a specified client service method) that are commonly defined between the state transition methods of the smart contract and the client service methods of the configurable client service logic. In some embodiments, at least one client service method of the one or more client service methods changes the one or more states in the smart contract. For example, as described with respect to FIG. 3, after execution of a client service method that leads to an updated state (e.g., a target state of a client service method), the configurable client service logic can include interfaces and logics to send a transaction request to upload or otherwise record the updated state on the blockchain and/or to trigger subsequent methods (e.g., either to be performed by the client service or other client services) specified in the workflow. In some embodiments, the client service can send the transaction directly to the blockchain network or to the coordinating node of the workflow to make a smart contract call to invoke one or more state transaction methods defined the smart contract to update the state.

At 408, the one or more smart contracts are deployed to the one or more blockchain networks. In some embodiments, the one or more smart contracts are sent by the coordinating node of the workflow and received by the one or more blockchain networks. In some embodiments, a smart contract is deployed at each consensus node of a blockchain network. In some embodiments, deploying the smart contract to the blockchain network includes compiling a script of the smart contract, creating a deploy transaction with the information of the smart contract (e.g., byte code of the smart contract, etc.), and sending the deploy transaction to a consensus node of the blockchain network. The consensus node that receives the deploy transaction can initiate a consensus procedure and distribute the deploy transaction to the other consensus nodes of the blockchain network. Each consensus node can verify the deploy transaction and if a consensus is reached among the consensus nodes, the smart contract can be successfully deployed to the blockchain network.

At 410, the one or more configurable client service logic are deployed to respective one or more client devices. In some embodiments, the one or more configurable client service logics are sent from the coordinating node of the workflow and received by the respective one or more client devices. The client device can expand, fill, complete, compile, or otherwise configure the client service logic so the client service logic is ready to be executed on the client service off the blockchain network.

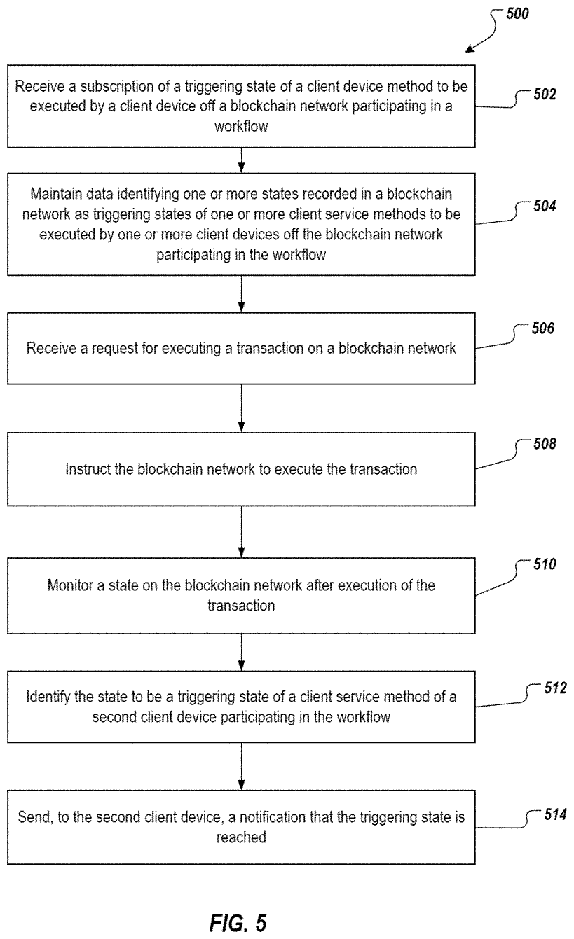

In some embodiments, after the one or more smart contracts are deployed to the blockchain network and the client service logics are deployed by a respective client device, the process 500 as described with respect to FIG. 5 can be performed to realize the workflow specified in the workflow specification.

FIG. 5 is a flowchart illustrating an example of a process 500 for implementation of a workflow that can be executed in accordance with embodiments of this specification. The process 500 can be a process performed by a workflow system in the context of FIG. 3. For convenience, the process 500 will be described as being performed by a system of one or more computers, located in one or more locations, and programmed appropriately in accordance with this specification. For example, the system 300 of FIG. 3, appropriately programmed, can perform the process 500.

At 502, a subscription of a triggering state is received, for example, by a network server (e.g., the cloud server 304) from a client device (e.g., the client device 370 or 375). The triggering event can be a triggering event of a client service method to be executed by a client device off a blockchain network participating in a workflow is received. In some embodiments, given the subscription, upon an occurrence of the triggering state on the blockchain network, the network server sends a notification of the triggering state to the client device.

In some embodiments, the network server can serve as an intermediate or coordinate node of the workflow. In some embodiments, the network server can be communicatively linked to one or more client devices and one or more blockchain networks. In some embodiments, the workflow can be a workflow in which is participated by a subset or all of the one or more client devices and one or more blockchain networks. For example, the workflow can be a workflow that is participated by a single client device and a single blockchain network. As another example, the workflow can be a multi-party workflow that is participated by the multiple client devices and the multiple blockchain networks. In some embodiments, the network server can receive multiple subscriptions of triggering states of one or more client service methods to be executed by one or more client devices off the blockchain network participating in the workflow.

At 504, data identifying one or more states recorded in a blockchain network as triggering states of one or more client service methods to be executed by one or more client devices off the blockchain network participating in a workflow are maintained, for example, by the network server (e.g., the cloud server 304). For example, as described with respect to FIG. 3, the cloud server 304 can receive workflow-related data (e.g., the states and/or events) from one or more blockchain networks participating in the workflow store (e.g., from the log file 320 or 325 and/or the blockchain 330 or 335). In some embodiments, the network server stores the workflow-related data on the network server, whereas the workflow-related data are not stored on any client devices participating in the workflow, thus relieving processing and storage requirements on the client devices participating in the workflow store and allowing the client devices to be lightweight devices.

At 506, a request for executing a transaction on a blockchain network is received, for example, by the network server from a first client device. In some embodiments, the request for executing the transaction on the blockchain network is in response to a first client service method (e.g., the client service method “Method A1” 362a) of the first client device (e.g., the cloud server 304) that has been executed by the first client device off the blockchain network (e.g., the blockchain network 302). In some embodiments, the request for executing the transaction on the blockchain network includes a request to record in the blockchain network one or more states and/or events (e.g., the target state “State A1” 372a) associated with the execution of the first client service method.

At 508, the blockchain network is instructed to execute the transaction, for example, by the network server. In some embodiments, instructing, by the network server, the blockchain network to execute the transaction comprises calling a smart contract deployed on the blockchain network to execute a state transition method on the blockchain network. For example, the network server can make a smart contract call to execute one or more state transition methods defined in the smart contract. In some embodiments, executing the smart contract results in the one or more states and/or events associated with the execution of the first client service method to be recorded in the blockchain network. In some embodiments, the smart contract was generated by the network server (e.g., the workflow configuration engine 340 of the cloud server 304).

At 510, a state on the blockchain network after execution of the transaction is monitored, for example, by the network server. In some embodiments, monitoring a state on the blockchain network after execution of the transaction comprises retrieving log data (e.g., from the log file 320 or the blockchain 330) stored on the blockchain network after execution of the transaction. In some embodiments, monitoring a state on the blockchain network can include constantly or regularly detecting, pulling, or otherwise receiving a state and/or event from the blockchain network 302 or 352. For example, the network server can monitor a state on the blockchain network by the subscribing to information (e.g., states and/or events related to the joint workflow) stored in the blockchain so that the blockchain network can push or otherwise send to the network server constantly or regularly (e.g., periodically) information stored in the blockchain.

At 512, it is identified, for example, by the network server, that the state is a triggering state of a client service method (e.g., the client service method “Method B2” 364b) of a second client device (e.g., the client device 375) participating in the workflow, where the client service method is executable by the second client device off the blockchain network. In some embodiments, the monitored state is compared against the triggering states of one or more client service methods registered at the network server so as to determine if the state is a triggering state of a client service method. If it is determined that the state is not a triggering state of any client service method registered at the network server, the network server can go back to 510 to keep monitoring the state on the blockchain network.

At 514, a notification that the triggering state is reached is sent, for example, by the network server to the second client device. In some embodiments, the notification can include an identification, a timestamp, or other information of the trigger state.

In some embodiments, the network server receives, from the second client device, a notification that a second state is reached after the client service method has been executed by the second client device off the blockchain network; and instructs the blockchain network to update the state of the blockchain network to the second state.

In some embodiments, the blockchain network is a first blockchain network and the network server is further communicatively linked with a second blockchain network. In some embodiments, a second current state on the second blockchain network is monitored, by the network server; it is identified that, by the network server, the second current state is a triggering state of a third client service method of a third client device participating in the workflow, wherein the third client service method is executable by the third client device off the second blockchain network; and a notification that the triggering state of the third client device method is reached is sent, by the network server, to the third client device.

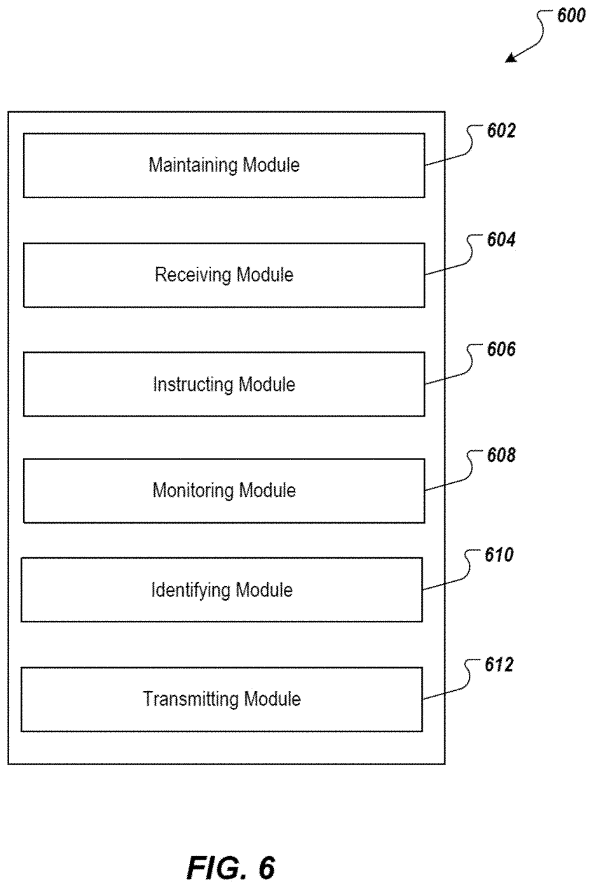

FIG. 6 depicts examples of modules of an apparatus 600 in accordance with embodiments of this specification. The apparatus 600 can be an example of an embodiment of a network server configured to implement a blockchain-based workflow. The apparatus 600 can correspond to the embodiments described above, and the apparatus 600 includes the following: a maintaining module 602 for maintaining data identifying one or more states recorded in a blockchain network as triggering states of one or more client service methods to be executed by one or more client devices off the blockchain network participating in a workflow; a receiving module 604 for receiving, from a first client device, a request for executing a transaction on a blockchain network; a instructing module 606 for instructing the blockchain network to execute the transaction; a monitoring module 608 for monitoring a state on the blockchain network after execution of the transaction; an identifying module 610 for identifying the state to be a triggering state of a client service method of a second client device participating in the workflow, wherein the client service method is executable by the second client device off the blockchain network; and a transmitting module 612 for sending, to the second client device, a notification that the triggering state is reached.

In an optional embodiment, the apparatus 600 further includes a receiving module for receiving, from the second client device, a subscription of the triggering state, wherein upon an occurrence of the triggering state on the blockchain network, the network server sends a notification of the triggering state to the second client device.

In an optional embodiment, monitoring a state on the blockchain network after execution of the transaction comprises retrieving log data stored on the blockchain network after execution of the transaction.

In an optional embodiment, the apparatus 600 further includes a storing module for storing the log data on the network server.

In an optional embodiment, the request for executing the transaction on the blockchain network is in response to a first client service method of the first client device that has been executed by the first client device off the blockchain network.

In an optional embodiment, instructing, by the network server, the blockchain network to execute the transaction comprises calling a smart contract deployed on the blockchain network to execute a state transition method on the blockchain network, wherein the smart contract was generated by the network server.

In an optional embodiment, the apparatus 600 further includes the following: a receiving module for receiving, from the second client device, a notification that a second state is reached after the client service method has been executed by the second client device off the blockchain network; and an instructing module for instructing the blockchain network to update the state of the blockchain network to the second state.

In an optional embodiment, instructing, by the network server, the blockchain network to update the state of the blockchain network to the second state comprises calling a smart contract deployed on the blockchain network to execute a state transition method on the blockchain network, wherein the smart contract was generated by the network server.

In an optional embodiment, the blockchain network is a first blockchain network and the network server is further communicatively linked with a second blockchain network. The apparatus 600 further includes the following: a monitoring module for monitoring a second current state on the second blockchain network; an identifying monitoring for identifying the second current state to be a triggering state of a third client service method of a third client device participating in the workflow, wherein the third client service method is executable by the third client device off the second blockchain network; and a transmitting module for sending, to the third client device, a notification that the triggering state of the third client device method is reached.

The system, apparatus, module, or unit illustrated in the previous embodiments can be implemented by using a computer chip or an entity, or can be implemented by using a product having a certain function. A typical embodiment device is a computer (and the computer can be a personal computer), a laptop computer, a cellular phone, a camera phone, a smartphone, a personal digital assistant, a media player, a navigation device, an email receiving and sending device, a game console, a tablet computer, a wearable device, or any combination of these devices.

For an embodiment process of functions and roles of each module in the apparatus, references can be made to an embodiment process of corresponding steps in the previous method. Details are omitted here for simplicity.

Because an apparatus embodiment basically corresponds to a method embodiment, for related parts, references can be made to related descriptions in the method embodiment. The previously described apparatus embodiment is merely an example. The modules described as separate parts may or may not be physically separate, and parts displayed as modules may or may not be physical modules, may be located in one position, or may be distributed on a number of network modules. Some or all of the modules can be selected based on actual demands to achieve the objectives of the solutions of the specification. A person of ordinary skill in the art can understand and implement the embodiments of the present application without creative efforts.

Referring again to FIG. 6, it can be interpreted as illustrating an internal functional module and a structure of a blockchain-based workflow implementation apparatus. The blockchain-based workflow implementation apparatus can be an example of a blockchain network node configured to implement a blockchain-based workflow. An execution body in essence can be an electronic device, and the electronic device includes the following: one or more processors; and one or more computer-readable memories configured to store an executable instruction of the one or more processors. In some embodiments, the one or more computer-readable memories are coupled to the one or more processors and have programming instructions stored thereon that are executable by the one or more processors to perform algorithms, methods, functions, processes, flows, and procedures, as described in this specification.

The techniques described in this specification produce several technical effects. In some embodiments, the workflow can be a joint workflow among multiple participants and each participant can be associated with a client device or network node of a blockchain network (e.g., client devices executing the client service logic and blockchain network nodes executing the smart contract). The techniques described herein associate the client service logic on the client side with the smart contracts on the blockchain side to form a complete workflow. In some embodiments, participants of the multi-party collaborative workflow can define a respective portion of the workflow specification according to individual needs, individually implement the client service methods of the client service logic, and complete the framework of the workflow. As such, a multi-party collaboration among the participants is proposed to achieve a multi-party collaborative workflow through blockchain smart contracts and client service logic.

In some embodiments, the multi-party blockchain-based workflow can be implemented to facilitate automatic generation of smart contracts (e.g., storing states of the blockchain network, generation of state transition methods, and providing role permission control for the state transition methods) according to a workflow specification. In some embodiments, clients or users of the workflow can focus on the implementation of the client service methods without paying too much attention to the details of how the client devices and the smart contract interact with each other. As such, the described techniques address the complexity of a multi-party collaborative workflow and improve efficiency of workflow systems.

Furthermore, in some embodiments, the smart contract stores states of workflow and events indicating change of states into a log file on the blockchain network. By storing the states and events in the log file on the blockchain network, information about the processing status of the workflow (i.e., the states of the workflow) can be more secure and reliable since the log file on the blockchain network is immutable. For example, malicious actors cannot tamper with the information about the states and events of the workflow to compromise the network. As such, the techniques as described herein improve security of the computer systems, networks, and database systems implementing the techniques.

Described embodiments of the subject matter can include one or more features, alone or in combination. For example, in a first embodiment, a method for implementing a blockchain-based workflow includes: maintaining, by a network server, data identifying one or more states recorded in a blockchain network as triggering states of one or more client service methods to be executed by one or more client devices off the blockchain network participating in a workflow; receiving, by the network server from a first client device, a request for executing a transaction on a blockchain network; instructing, by the network server, the blockchain network to execute the transaction; monitoring, by the network server, a state on the blockchain network after execution of the transaction; identifying, by the network server, the state to be a triggering state of a client service method of a second client device participating in the workflow, wherein the client service method is executable by the second client device off the blockchain network; and sending, by the network server to the second client device, a notification that the triggering state is reached.

In other embodiments, one or more of an apparatus, a non-transitory computer-readable storage medium, and a system are provided for implementing the methods provided herein. For example, an apparatus can be a network server or a network node of a blockchain network for implementing the methods provided herein. As another example, a system can include a network server, one or more client devices, and one or more blockchain network for implementing the methods provided herein. For example, the network server is communicatively linked with the one or more client devices and the one or more blockchain networks. The network server is configured to implement the method as described in the first embodiment. One of the one or more client devices can be configured to serve as a first client device that sends to the network server, a request for executing a transaction on a blockchain network, for example, in response to in response to a first client service method of the first client device that has been executed by the first client device off the blockchain network. One of the one or more client devices can be configured to serve as a second client device that receives, from the network server, a notification of a triggering state of a client service method of a second client device participating in the workflow, and then executes the client service method by the second client device off the blockchain network.

The foregoing and other described embodiments can each, optionally, include one or more of the following features:

A first feature, combinable with any of the following features, specifies that the method further comprising receiving, by the network server from the second client device, a subscription of the triggering state, wherein upon an occurrence of the triggering state on the blockchain network, the network server sends a notification of the triggering state to the second client device.

A second feature, combinable with any of the previous or following features, specifies that monitoring, by the network server, a state on the blockchain network after execution of the transaction comprises retrieving log data stored on the blockchain network after execution of the transaction.

A third feature, combinable with any of the previous or following features, specifies that the method further comprising storing the log data on the network server.

A fourth feature, combinable with any of the previous or following features, specifies that the log data are not stored in the first client device nor the second client device.

A fifth feature, combinable with any of the previous or following features, specifies that the request for executing the transaction on the blockchain network is in response to a first client service method of the first client device that has been executed by the first client device off the blockchain network.

A sixth feature, combinable with any of the previous or following features, specifies that instructing, by the network server, the blockchain network to execute the transaction comprises calling a smart contract deployed on the blockchain network to execute a state transition method on the blockchain network, wherein the smart contract was generated by the network server.

A seventh feature, combinable with any of the previous or following features, specifies that the method further includes: receiving, by the network server from the second client device, a notification that a second state is reached after the client service method has been executed by the second client device off the blockchain network; and instructing, by the network server, the blockchain network to update the state of the blockchain network to the second state.

An eighth feature, combinable with any of the previous or following features, specifies that instructing, by the network server, the blockchain network to update the state of the blockchain network to the second state comprises calling a smart contract deployed on the blockchain network to execute a state transition method on the blockchain network, wherein the smart contract was generated by the network server.

An ninth feature, combinable with any of the previous or following features, specifies that the blockchain network is a first blockchain network and the network server is further communicatively linked with a second blockchain network, the method further comprising: monitoring, by the network server, a second current state on the second blockchain network; identifying, by the network server, the second current state to be a triggering state of a third client service method of a third client device participating in the workflow, wherein the third client service method is executable by the third client device off the second blockchain network; and sending, by the network server to the third client device, a notification that the triggering state of the third client device method is reached.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions, encoded on a computer program carrier, for execution by, or to control the operation of, data processing apparatus. For example, a computer program carrier can include one or more computer-readable storage media that have instructions encoded or stored thereon. The carrier may be a tangible non-transitory computer-readable medium, such as a magnetic, magneto optical, or optical disk, a solid state drive, a random access memory (RAM), a read-only memory (ROM), or other types of media. Alternatively, or in addition, the carrier may be an artificially generated propagated signal, e.g., a machine-generated electrical, optical, or electromagnetic signal that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

Processors for execution of a computer program include, by way of example, both general- and special-purpose microprocessors, and any one or more processors of any kind of digital computer. Generally, a processor will receive the instructions of the computer program for execution as well as data from a non-transitory computer-readable medium coupled to the processor.

The term “data processing apparatus” encompasses all kinds of apparatuses, devices, and machines for processing data, including by way of example a programmable processor, a computer, or multiple processors or computers. Data processing apparatus can include special-purpose logic circuitry, e.g., an FPGA (field programmable gate array), an ASIC (application specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

The processes and logic flows described in this specification can be performed by one or more computers or processors executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read only memory or a random access memory or both. Elements of a computer can include a central processing unit for executing instructions and one or more memory devices for storing instructions and data. The central processing unit and the memory can be supplemented by, or incorporated in, special-purpose logic circuitry.

Generally, a computer will also include, or be operatively coupled to receive data from or transfer data to one or more storage devices. The storage devices can be, for example, magnetic, magneto optical, or optical disks, solid state drives, or any other type of non-transitory, computer-readable media. However, a computer need not have such devices. Thus, a computer may be coupled to one or more storage devices, such as, one or more memories, that are local and/or remote. For example, a computer can include one or more local memories that are integral components of the computer, or the computer can be coupled to one or more remote memories that are in a cloud network. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Components can be “coupled to” each other by being commutatively such as electrically or optically connected to one another, either directly or via one or more intermediate components. Components can also be “coupled to” each other if one of the components is integrated into the other. For example, a storage component that is integrated into a processor (e.g., an L2 cache component) is “coupled to” the processor.

To provide for interaction with a user, embodiments of the subject matter described in this specification can be implemented on, or configured to communicate with, a computer having a display device, e.g., a LCD (liquid crystal display) monitor, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

While this specification contains many specific embodiment details, these should not be construed as limitations on the scope of what is being claimed, which is defined by the claims themselves, but rather as descriptions of features that may be specific to particular embodiments. Certain features that are described in this specification in the context of separate embodiments can also be realized in combination in a single embodiment. Conversely, various features that are described in the context of a single embodiments can also be realized in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method comprising:
maintaining, by a network server communicatively linked to one or more client devices and one or more blockchain networks, data tracking a workflow that is participated in by the one or more client devices and the one or more blockchain networks,
wherein the data identify one or more states recorded in the one or more blockchain networks as triggering states of one or more client service methods executable by the one or more client devices off the one or more blockchain networks participating in the workflow,
wherein the triggering states automatically trigger execution of the one or more client service methods by the one or more client devices,
wherein the one or more states are defined in one or more state transition methods in one or more smart contracts executable on the one or more blockchain networks, and
wherein the one or more states comprise a first state and a second state;
generating, by the network server, a first smart contract for a first blockchain network, wherein the first smart contract comprises a first state transition method to be executed by the first blockchain network, the first state transition method receives the first state as an input to the first state transition method, wherein the first state results from execution of a first client service method by a first client device participating in the workflow, and the first state is a triggering state of a second client service method of a second client device participating in the workflow, and wherein the first client service method is executable by the first client device off the first blockchain network, and the second client service method is executable by the second client device off the first blockchain network;
sending, by the network server, the first smart contract to the first blockchain network for deployment on the first blockchain network;
generating, by the network server, a second smart contract for a second blockchain network, wherein the second smart contract comprises a second state transition method to be executed by the second blockchain network, the second state transition method receives the second state as an input to the second state transition method, wherein the second state results from execution of the second client service method by the second client device participating in the workflow; and
sending, by the network server, the second smart contract to the second blockchain network for deployment on the second blockchain network;
receiving, by the network server from the first client device, a request for executing a transaction on the first blockchain network in response to the first client service method of the first client device that has been executed by the first client device off the first blockchain network;
instructing, by the network server, the first blockchain network to execute the transaction by calling the first smart contract deployed on the first blockchain network to execute the first state transition method on the first blockchain network to record the first state on the first blockchain network;
monitoring, by the network server, a state on the first blockchain network after execution of the transaction;
identifying, by the network server, that the state on the first blockchain network is the first state;
in response to identifying that the state on the first blockchain network is the first state that is the triggering state of the second client service method of the second client device participating in the workflow, sending, by the network server to the second client device, a notification that the triggering state of the second client service method is reached;
receiving, by the network server from the second client device, a notification that the second state is reached after the second client service method of the second client device has been executed by the second client device off the first blockchain network; and
instructing, by the network server, the second blockchain network to record the second state on the second blockchain network by calling the second smart contract deployed on the second blockchain network to execute the second state transition method on the second blockchain network.

2. The computer-implemented method of claim 1, further comprising receiving, by the network server from the second client device, a subscription of the triggering state, wherein upon an occurrence of the triggering state on the first blockchain network, the network server sends a notification of the triggering state to the second client device.

3. The computer-implemented method of claim 1, wherein monitoring, by the network server, a state on the first blockchain network after execution of the transaction comprises retrieving log data stored on the first blockchain network after execution of the transaction.

4. The computer-implemented method of claim 3, further comprising storing the log data on the network server.

5. The computer-implemented method of claim 3, wherein the log data are not stored in the first client device nor the second client device.

6. The computer-implemented method of claim 1, further comprising:
generating, by the network server, the one or more client service methods; and
sending, by the network server, the one or more client service methods to the one or more client devices, wherein the one or more client service methods are configurable by the one or more client devices.

7. The computer-implemented method of claim 1, wherein the second state is a triggering state of a third client service method of a third client device participating in the workflow, wherein the third client service method is executable by the third client device off the second blockchain network,
the method further comprising:
monitoring, by the network server, a current state on the second blockchain network;
identifying, by the network server, the current state on the second blockchain network is the second state; and
in response to identifying that the current state on the second blockchain network is the second state that is the triggering state of the third client service method of the third client device participating in the workflow, sending, by the network server to the third client device, a notification that the triggering state of the third client service method is reached.

8. The computer-implemented method of claim 1, wherein maintaining, by the network server, the data tracking the workflow comprises: synchronizing, by the network server, with blockchains of the first blockchain network and the second blockchain network.

9. The computer-implemented method of claim 1, wherein the data are stored in the network server but not in the first client device, nor in the second client device.

10. The computer-implemented method of claim 1, further comprising:
receiving, by the network server from the first client device, another request for executing another transaction on the first blockchain network;
determining, by the network server, whether a blockchain account associated with the first client device is authorized to make the another request to execute the another transaction on the first blockchain network; and
in response to determining that the blockchain account associated with the first client device is not authorized to make the another request to execute the another transaction on the first blockchain network, rejecting, by the network server, the another request from the first client device.

11. A non-transitory, computer-readable storage medium storing one or more instructions executable by a computer system to perform operations for implementing a blockchain-based workflow, the operations comprising:
maintaining, by a network server communicatively linked to one or more client devices and one or more blockchain networks, data related to tracking a workflow that is participated in by the one or more client devices and the one or more blockchain networks,
wherein the data identify one or more states recorded in the one or more blockchain networks as triggering states of one or more client service methods executable by the one or more client devices off the one or more blockchain networks participating in the workflow,
wherein the triggering states automatically trigger execution of the one or more client service methods by the one or more client devices,
wherein the one or more states are defined in one or more state transition methods in one or more smart contracts executable on the one or more blockchain networks, and
wherein the one or more states comprise a first state and a second state;
generating, by the network server, a first smart contract for a first blockchain network, wherein the first smart contract comprises a first state transition method to be executed by the first blockchain network, the first state transition method receives the first state as an input to the first state transition method, wherein the first state results from execution of a first client service method by a first client device participating in the workflow, and the first state is a triggering state of a second client service method of a second client device participating in the workflow, and wherein the first client service method is executable by the first client device off the first blockchain network, and the second client service method is executable by the second client device off the first blockchain network;
sending, by the network server, the first smart contract to the first blockchain network for deployment on the first blockchain network;
generating, by the network server, a second smart contract for a second blockchain network, wherein the second smart contract comprises a second state transition method to be executed by the second blockchain network, the second state transition method receives the second state as an input to the second state transition method, wherein the second state results from execution of the second client service method by the second client device participating in the workflow; and
sending, by the network server, the second smart contract to the second blockchain network for deployment on the second blockchain network;
receiving, by the network server from the first client device, a request for executing a transaction on the first blockchain network in response to the first client service method of the first client device that has been executed by the first client device off the first blockchain network;
instructing, by the network server, the first blockchain network to execute the transaction by calling the first smart contract deployed on the first blockchain network to execute the first state transition method on the first blockchain network to record the first state on the first blockchain network;
monitoring, by the network server, a state on the first blockchain network after execution of the transaction;
identifying, by the network server, that the state on the first blockchain network is the first state;
in response to identifying that the state on the first blockchain network is the first state that is the triggering state of the second client service method of the second client device participating in the workflow, sending, by the network server to the second client device, a notification that the triggering state of the second client service method is reached;
receiving, by the network server from the second client device, a notification that the second state is reached after the second client service method of the second client device has been executed by the second client device off the first blockchain network; and
instructing, by the network server, the second blockchain network to record the second state on the second blockchain network by calling the second smart contract deployed on the second blockchain network to execute the second state transition method on the second blockchain network.

12. The non-transitory, computer-readable storage medium of claim 11, the operations further comprising receiving, by the network server from the second client device, a subscription of the triggering state, wherein upon an occurrence of the triggering state on the first blockchain network, the network server sends a notification of the triggering state to the second client device.

13. The non-transitory, computer-readable storage medium of claim 11, wherein monitoring, by the network server, a state on the first blockchain network after execution of the transaction comprises retrieving log data stored on the first blockchain network after execution of the transaction.

14. The non-transitory, computer-readable storage medium of claim 13, further comprising storing the log data on the network server.

15. The non-transitory, computer-readable storage medium of claim 13, wherein the log data are not stored in the first client device nor the second client device.

16. The non-transitory, computer-readable storage medium of claim 11, the operations further comprising:
generating, by the network server, the one or more client service methods; and
sending, by the network server, the one or more client service methods to the one or more client devices, wherein the one or more client service methods are configurable by the one or more client devices.

17. The non-transitory, computer-readable storage medium of claim 11, wherein the second state is a triggering state of a third client service method of a third client device participating in the workflow, wherein the third client service method is executable by the third client device off the second blockchain network,
the operations further comprising:
monitoring, by the network server, a current state on the second blockchain network;
identifying, by the network server, the current state on the second blockchain network is the second state; and
in response to identifying that the current state on the second blockchain network is the second state that is the triggering state of the third client service method of the third client device participating in the workflow, sending, by the network server to the third client device, a notification that the triggering state of the third client service method is reached.

18. The non-transitory, computer-readable storage medium of claim 11, wherein maintaining, by the network server, the data tracking the workflow comprises: synchronizing, by the network server, with blockchains of the first blockchain network and the second blockchain network.

19. The non-transitory, computer-readable storage medium of claim 11, wherein the data are stored in the network server but not in the first client device, nor in the second client device.

20. The non-transitory, computer-readable storage medium of claim 11, the operations further comprising:
receiving, by the network server from the first client device, another request for executing another transaction on the first blockchain network;
determining, by the network server, whether a blockchain account associated with the first client device is authorized to make the another request to execute the another transaction on the first blockchain network; and
in response to determining that the blockchain account associated with the first client device is not authorized to make the another request to execute the another transaction on the first blockchain network, rejecting, by the network server, the another request from the first client device.

21. A system for implementing a blockchain-based workflow, comprising:
one or more processors; and
one or more computer-readable memories coupled to the one or more processors and having instructions stored thereon that are executable by the one or more processors to perform operations comprising:
maintaining, by a network server communicatively linked to one or more client devices and one or more blockchain networks, data tracking a workflow that is participated in by the one or more client devices and the one or more blockchain networks,
wherein the data identify one or more states recorded in the one or more blockchain networks as triggering states of one or more client service methods executable by the one or more client devices off the one or more blockchain networks participating in the workflow,
wherein the triggering states automatically trigger execution of the one or more client service methods by the one or more client devices,
wherein the one or more states are defined in one or more state transition methods in one or more smart contracts executable on the one or more blockchain networks, and
wherein the one or more states comprise a first state and a second state;
generating, by the network server, a first smart contract for a first blockchain network, wherein the first smart contract comprises a first state transition method to be executed by the first blockchain network, the first state transition method receives the first state as an input to the first state transition method, wherein the first state results from execution of a first client service method by a first client device participating in the workflow, and the first state is a triggering state of a second client service method of a second client device participating in the workflow, and wherein the first client service method is executable by the first client device off the first blockchain network, and the second client service method is executable by the second client device off the first blockchain network;
sending, by the network server, the first smart contract to the first blockchain network for deployment on the first blockchain network;
generating, by the network server, a second smart contract for a second blockchain network, wherein the second smart contract comprises a second state transition method to be executed by the second blockchain network, the second state transition method receives the second state as an input to the second state transition method, wherein the second state results from execution of the second client service method by the second client device participating in the workflow; and
sending, by the network server, the second smart contract to the second blockchain network for deployment on the second blockchain network;
receiving, by the network server from the first client device, a request for executing a transaction on the first blockchain network in response to the first client service method of the first client device that has been executed by the first client device off the first blockchain network;
instructing, by the network server, the first blockchain network to execute the transaction by calling the first smart contract deployed on the first blockchain network to execute the first state transition method on the first blockchain network to record the first state on the first blockchain network;
monitoring, by the network server, a state on the first blockchain network after execution of the transaction;
identifying, by the network server, that the state on the first blockchain network is the first state;
in response to identifying that the state on the first blockchain network is the first state that is the triggering state of the second client service method of the second client device participating in the workflow, sending, by the network server to the second client device, a notification that the triggering state of the second client service method is reached;
receiving, by the network server from the second client device, a notification that the second state is reached after the second client service method of the second client device has been executed by the second client device off the first blockchain network; and
instructing, by the network server, the second blockchain network to record the second state on the second blockchain network by calling the second smart contract deployed on the second blockchain network to execute the second state transition method on the second blockchain network.

22. The system of claim 21, the operations further comprising receiving, by the network server from the second client device, a subscription of the triggering state, wherein upon an occurrence of the triggering state on the first blockchain network, the network server sends a notification of the triggering state to the second client device.

23. The system of claim 21, wherein monitoring, by the network server, a state on the first blockchain network after execution of the transaction comprises retrieving log data stored on the first blockchain network after execution of the transaction.

24. The system of claim 23, the operations further comprising storing the log data on the network server.

25. The system of claim 23, wherein the log data are not stored in the first client device nor the second client device.

26. The system of claim 21, the operations further comprising:
generating, by the network server, the one or more client service methods; and
sending, by the network server, the one or more client service methods to the one or more client devices, wherein the one or more client service methods are configurable by the one or more client devices.

27. The system of claim 21, wherein the second state is a triggering state of a third client service method of a third client device participating in the workflow, wherein the third client service method is executable by the third client device off the second blockchain network,
the operations further comprising:
monitoring, by the network server, a current state on the second blockchain network;
identifying, by the network server, the current state on the second blockchain network is the second state; and
in response to identifying that the current state on the second blockchain network is the second state that is the triggering state of the third client service method of the third client device participating in the workflow, sending, by the network server to the third client device, a notification that the triggering state of the third client service method is reached.

28. The system of claim 21, wherein maintaining, by the network server, the data tracking the workflow comprises: synchronizing, by the network server, with blockchains of the first blockchain network and the second blockchain network.

29. The system of claim 21, wherein the data are stored in the network server but not in the first client device, nor in the second client device.

30. The system of claim 21, the operations further comprising:
receiving, by the network server from the first client device, another request for executing another transaction on the first blockchain network;
determining, by the network server, whether a blockchain account associated with the first client device is authorized to make the another request to execute the another transaction on the first blockchain network; and
in response to determining that the blockchain account associated with the first client device is not authorized to make the another request to execute the another transaction on the first blockchain network, rejecting, by the network server, the another request from the first client device.
